(19) United States
(12) Patent Application Publication
(10) Pub. No.: US 2006/0204826 A1
(43) Pub. Date: Sep. 14, 2006

(54) Geometric feature driven flow equalization in fuel cell stack gas flow separator

(75) Inventor: Bruce Borchers, Santa Cruz, CA (US)

Correspondence Address: FOLEY AND LARDNER LLP;SUITE 500, 3000 K STREET NW, WASHINGTON, DC, 20007, US

(73) Assignee: Ion America Corporation

(21) Appl. No.: 11/076,102

(22) Filed: Mar. 9, 2005

(51) Int. Cl. H01M 8/02

(52) U.S. Cl. 429/38; 429/13

(57) ABSTRACT

A gas flow separator for a fuel cell stack includes a plurality of gas flow channels and a gas flow restrictor located in each channel. Each gas flow restrictor may be a geometric feature which restricts gas flow in each respective channel.

### BACKGROUND OF THE INVENTION

The present invention is generally directed to fuel cell components and more specifically to fuel cell stack gas flow separator configuration.

Fuel cells are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide reversible fuel cells, that also allow reversed operation, such that water or other oxidized fuel can be reduced to unoxidized fuel using electrical energy as an input.

In a high temperature fuel cell system such as a solid oxide fuel cell (SOFC) system, an oxidizing flow is passed through the cathode side of the fuel cell while a fuel flow is passed through the anode side of the fuel cell. The oxidizing flow is typically air, while the fuel flow is typically a hydrogen-rich gas created by reforming a hydrocarbon fuel source. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit.

Fuel cell stacks are frequently built from a multiplicity of cells in the form of planar elements, tubes, or other geometries. Fuel and air has to be provided to the electrochemically active surface, which can be large. One component of a fuel cell stack is the so called gas flow separator (referred to as a gas flow separator plate in a planar stack) that separates the individual cells in the stack. The gas flow separator plate separates fuel, such as hydrogen or a hydrocarbon fuel, flowing to the fuel electrode (i.e., anode) of one cell in the stack from oxidant, such as air, flowing to the air electrode (i.e., cathode) of an adjacent cell in the stack. Frequently, the gas flow separator plate is also used as an interconnect which electrically connects the fuel electrode of one cell to the air electrode of the adjacent cell. In this case, the gas flow separator plate which functions as an interconnect is made of or contains an electrically conductive material.

Fuel cell stacks may be either internally or externally manifolded for fuel and air. In internally manifolded stacks, the fuel and air is distributed to each cell using risers contained within the stack. In other words, the gas flows through openings or holes in the supporting layer of each fuel cell, such as the electrolyte layer, and gas separator of each cell. In externally manifolded stacks, the stack is open on the fuel and air inlet and outlet sides, and the fuel and air are introduced and collected independently of the stack hardware. For example, the inlet and outlet fuel and air flow in separate channels between the stack and the manifold housing in which the stack is located.

The efficiency of a fuel cell, which is defined as the amount of electrical energy generated per energy provided in the form of fuel is strongly affected by the “fuel utilization.” “Fuel utilization” is the fraction of fuel supplied which is electrochemically reacted within the cell. High fuel utilizations often result from even or well equalized fuel flow over all active areas. If any area suffers from low flow rates, this area will be subject to fuel starvation, which can cause irreversible damage of the fuel cell.

Good fuel distribution is usually achieved by a cascading network of flow channels. “Flow channels” is a broad term applicable to large and long macroscopic conduits as well as to microscopic porous fluid containments. One type of flow channels are located in the gas flow separator, with the fuel flow channels being provided on the fuel side of the gas flow separator and the air flow channels being provided on the air side of the gas flow separator.

A cascading flow network refers to a system where one main gas supply first splits into several flow streams (e.g., to several stacks), then again to more flow streams (e.g., several streams in each stack), and then again to more channels (e.g., multiple channels in one gas flow separator plate). The number of levels in this cascade can vary anywhere between two (the minimum required for any cascade) up to 10 or more levels. Typical systems consist of three to four distribution levels.

In order to achieve equal flow in all lowest level channels (i.e., the channels in the gas flow separator plate), the channels are typically designed such that they create the largest pressure drop within the system. If the pressure drop in this lowest level is much larger than all other pressure drops, all other pressure drops will have negligible effect on the flow distribution. Thus, it is desirable that all flow channels on the lowest level experience the same pressure drop. This can create engineering challenges and drive machining tolerances to very tight levels. For instance, in a channel with a 1.5 mm hydraulic diameter, tolerances in vicinity of 10 micrometer can create significant misdistributions of flow.

### BRIEF SUMMARY OF THE INVENTION

One embodiment of present invention provides a gas flow separator for a fuel cell stack including a plurality of gas flow channels and a gas flow restrictor located in each channel.

### BRIEF DESCRIPTION OF THE DRAWINGS

FIGS. 1, 2, 3 and 4 are schematic top views of cut-away portions of gas flow separators of the embodiments of the present invention.

FIG. 5 is a top view of a gas flow separator of one embodiment of the present invention.

FIG. 6 is a side cross sectional view of a portion of a fuel cell stack of an embodiment of the present invention.

### DETAILED DESCRIPTION OF THE PREFERRED EMBODIMENTS

The inventor has realized that tolerances for the lowest level gas flow channels, such as the flow channels in the gas flow separator, can be relaxed if a gas flow restrictor is provided in the channels. The gas flow restrictor preferably comprises any suitable geometric feature or features which restrict gas flow in the gas flow separator channels and which thus governs the pressure drop in the channels.

In one embodiment of the invention, the gas flow restrictor geometric feature comprises at least one turn in each respective channel of the gas flow separator. For example, the geometric feature may comprise at least one turn of at least 60 degrees, such as at least one turn of 80 to 100 degrees.

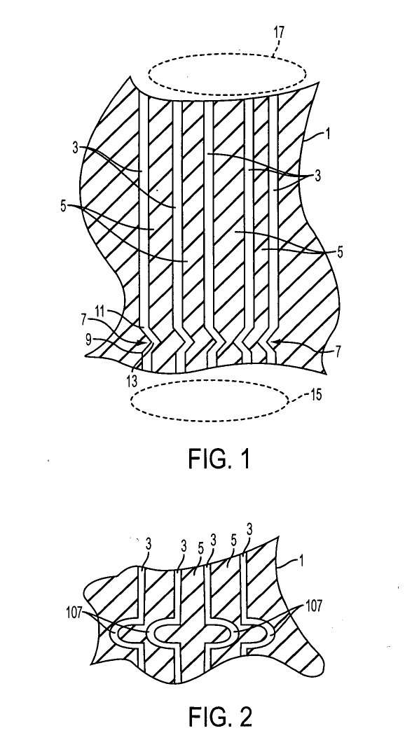

More preferably, the geometric feature comprises a plurality of turns. In another example, the geometric feature comprises a chevron shaped feature shown in FIG. 1 having three turns. FIG. 1 shows a plate shaped gas flow separator 1 for a planar fuel cell stack. The separator 1 contains a plurality of gas flow channels 3 separated from each other by walls or ridges 5. Each channel 3 contains a chevron or “V” shaped gas flow restrictor 7. In other words, each channel 3 contains a mitered corner 7. The gas flow restrictor includes first 9 and third 11 turns of about 60 degrees and a second turn 13 of about 90 degrees located between the first and the third turns. The term “about 90 degrees” includes turns of exactly 90 degrees and turns which deviate by 1 to 15 percent from 90 degrees while still maintaining a chevron shape of the gas flow restrictor 7. The chevron shaped feature 7 in the fuel flow field effectively creates three sharp turns in the flow field. The pressure drop induced by these three turns is the highest within the system and thereby governs the flow distribution.

The pressure drop in the channels may be determined from dynamic head loss calculations. For example, a pressure drop in a mitered corner may be calculated by multiplying a local loss coefficient by the dynamic pressure. The Handbook of Hydraulic Resistance, 2^{nd} edition (Idelchik, I. E., Malyavskaya, G. R., Martynenko, O. G. and Fried, E., authors, Hemisphere Publishing Corp., a subsidiary of Harper & Row, New York, 1986) provides local loss coefficients for air channel geometry, and a square cross section, 90 degree mitered turn has a local loss coefficient of 1.2. Thus, by placing multiple mitered corners in parallel and/or in series, a significant pressure drop may be achieved, which may provide advantages over orifice or porous media (frit) flow restrictors.

It should be noted that while the flow restrictors 7 are described with respect to a fuel cell stack gas separator plate, they are not limited to use in fuel cell systems or electrochemical systems, such as electrolyzer systems. The flow restrictors described herein may be used in any suitable device where it is desirable to restrict a flow of gas or liquid.

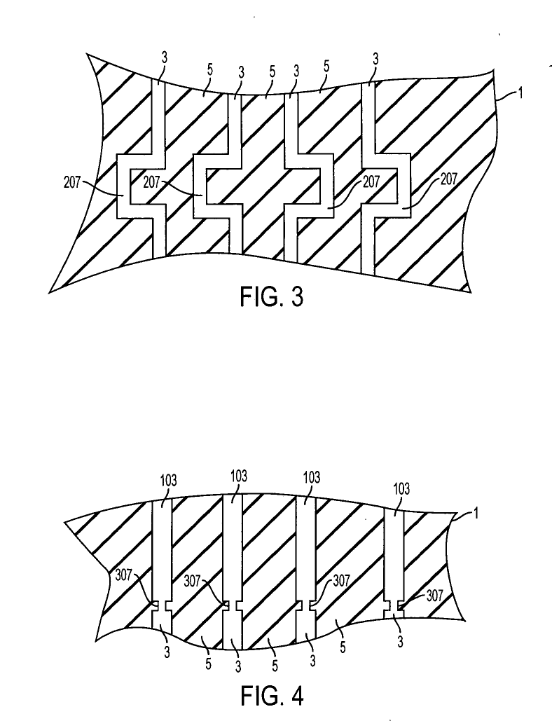

It should be noted that the chevron shaped gas flow restrictor 7 comprises only one example of the gas flow restrictor. For example, the gas flow restrictor may comprise a “U” shaped feature 107 where the gas makes a 180 degree turn in the gas flow channel 3 as shown in FIG. 2, a “Π” shaped feature 207 where the gas makes four 90 degree turns in the gas flow channel, as shown in FIG. 3 or any other geometric feature having one or more turns.

In a second embodiment of the invention shown in FIG. 4, the flow restrictor geometric feature comprises a first portion 307 of each channel 3 which has a narrower width than a second portion 103 of each channel 3. In other words, the flow restrictor may comprise a narrow portion of each channel which has a narrower width than the rest of the channel.

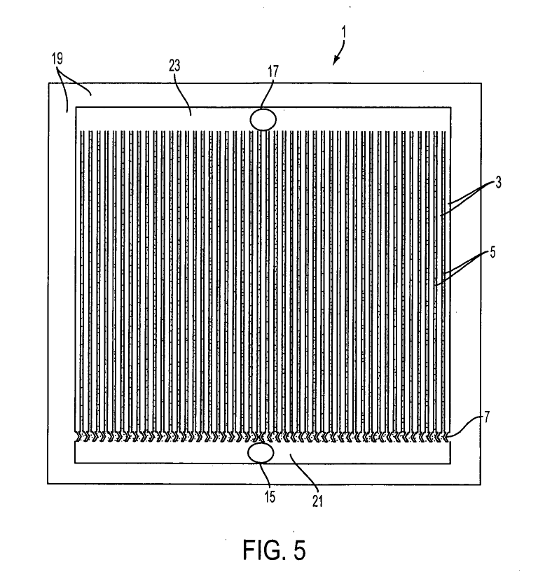

In a third embodiment of the invention, the gas flow restrictors contain at least one turn of the first embodiment of the invention and have a narrower width than the rest of the channel of the second embodiment. For example, FIG. 5 shows an example of the chevron shaped flow restrictors 7 which have a narrower width than the flow channels 3. The channels 3 may have a width of several tens of microns to several centimeters, for example 100 microns to 10 cm, such as 0.1 mm to 10 mm, depending on the size of the fuel cell stack and other factors. The flow restrictors preferably have a width that is the same as or smaller than the width of the channels 3, but generally of the same size scale (i.e., millimeter scale flow restrictors for millimeter scale channels). For example, the width of the flow restrictors may be 30 to 100 percent, such as 60 to 90 percent, of the width of the channels. It should be noted that in some cases the flow restrictors may be wider than the channels if the turns in the flow restrictors are sufficient to control the pressure drop across the channels.

Preferably, the gas flow separator comprises a plate shaped gas flow separator shown in FIG. 5 for a planar type fuel cell stack. However, the gas flow separator may have other shapes for tubular and other non-planar type stacks. The gas flow restrictors 7, 107, 207, 307 are preferably located on at least the fuel side of the gas flow separator 1. However, if desired, the gas flow restrictors may also be located on the air side of the gas flow separator.

As shown in FIG. 1, the gas flow separator 1 contains a gas inlet opening 15 and a gas outlet opening 17. For externally manifolded fuel cell stacks, the openings 15 and 17 comprise open edges of the gas flow separator 1. For internally manifolded fuel cell stacks, the openings comprise riser openings in the gas flow separator 1 itself.

For example, FIG. 5 shows an example of a gas flow separator 1 for a fuel cell stack that is externally manifolded on the air side and internally manifolded on the fuel side. In the example of FIG. 5, the separator is shown as having its fuel side facing up and its air side facing down (i.e., the air side is not shown in FIG. 5). Thus, the fuel is provided through the fuel riser openings 15, 17 within the stack and which extend through the separator plate 1. The separator 1 contains seals 19 which seal the periphery of the separator 1, such that the fuel flows from fuel inlet riser opening 15 to an inlet manifold recess 21, through the channels 3 containing the gas flow restrictors 7 to an outlet manifold recess 23, from where the fuel is collected in the fuel outlet riser opening 17. The seals 19 prevent the fuel from entering at or exiting from the edges of the separator 1. The gas flow restrictors 7 may be positioned anywhere in the channels 3, such as closer to the inlet opening 15, closer to the outlet opening 17 or about half way between openings 15 and 17. In contrast, the separator is open on the air inlet and outlet sides (not shown in FIG. 5) and air is provided and collected independent of the stack hardware. Thus, the separators lack air or oxidizer inlet and outlet riser openings. Alternatively, as noted above, the stack may be internally or externally manifolded for both air and fuel.

Thus, as shown in FIG. 5, the gas inlet opening (i.e., fuel inlet opening) 15 is in fluid communication with the gas outlet opening (i.e., fuel outlet opening) 17 through the plurality of channels 3. Preferably, a straight line path does not exist between the gas inlet opening 15 and the gas outlet opening 17 through the plurality of channels 3. In other words, the gas flow restrictors 7 in each channel 3 force all gas, such as the fuel, passing through the channels to make at least one turn, such that the gas cannot travel in a straight line from opening 15 to opening 17 through the channels.

As shown in FIGS. 1 and 5, a tight right angle bend 13 in a channel 3 can generate a pressure drop much larger than the same channel in a straight configuration. It is relatively easy to reproduce sharp corners in the flow field compared to micrometer scale tolerances in the lateral dimensions of the flow channels. This facilitates flow field equalization within fuel cells. It is projected that the chevron containing gas flow separator design may be operated at fuel utilizations up to 85 percent, for example 70 to 85 percent such as 80 to 85 percent, which is remarkably high.

The gas flow separator 1 may be made of any suitable material, such as a metal or ceramic material. If the gas flow separator 1 also comprises an interconnect, then the separator may be made of an electrically conductive metal or ceramic or it may be made of an electrically insulating ceramic with conductive feed throughs. The walls 5 of the channels may be made of the same material as the separator 1 (i.e., the channels 3 comprise grooves and the walls 5 comprise ridges in a surface of the separator). Alternatively, the walls 5 may be made of a different material from the material of the separator 1. For example, the walls 5 may comprise portions of a layer formed on the separator which has been patterned to contain the channels. For example, the layer may comprise a glass or another compliant seal layer which is patterned to form the walls 5 and peripheral seals 19 which circumscribe the channels 3 and manifold recesses 21, 23.

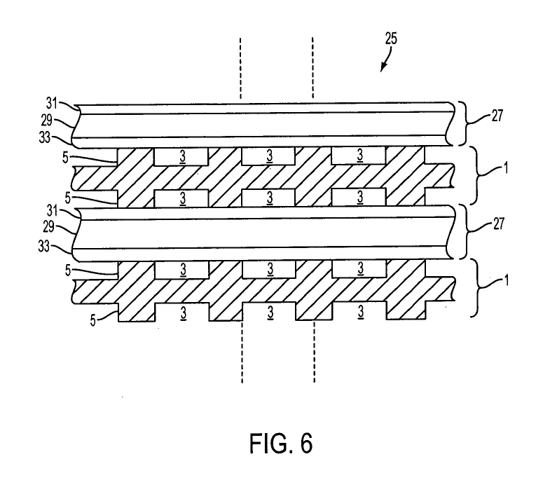

FIG. 6 shows a side cross sectional view of a planar fuel cell stack 25, which includes a plurality of fuel cells 27 and a plurality of plate shaped gas flow separators 1 separating adjacent fuel cells. Preferably, each fuel cell comprises a solid oxide fuel cell. Each fuel cell contains an electrolyte 29, a fuel (i.e., anode) electrode 31 electrically contacting the fuel side of the gas flow separator 1 and an air (i.e., cathode) electrode 33 electrically contacting the air side of another gas flow separator. Alternatively, the gas flow separators 1 may be incorporated into fuel cell stacks containing fuel cells other than solid oxide fuel cells, such as molten carbonate fuel cells, for example. The fuel cells 27 may be designed to operate as reversible or non-reversible fuel cells.

Preferably, the stack 25 comprises a multiple level cascading fuel flow system, and the gas flow separators 7, 107, 207, 307 equalize fuel flow rate among the multiple flow levels. The stack 25 operates by providing an oxidizer flow, such as an air flow to the fuel cells and providing a fuel, such as a hydrogen or hydrocarbon (methane, natural gas, etc.) flow through the plurality of flow channels containing the gas flow restrictors and generating electricity in the fuel cells. The gas flow restrictors restrict fuel flow in the gas flow channels and govern a pressure drop in the gas flow channels.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A gas flow separator for a fuel cell stack comprising a plurality of gas flow channels and a gas flow restrictor located in each channel.

2. The separator of claim 1, wherein each gas flow restrictor comprises a geometric feature which restricts gas flow in each respective channel.

3. The separator of claim 2, wherein the geometric feature comprises at least one turn in each respective channel.

4. The separator of claim 3, wherein the geometric feature comprises at least one turn of at least 60 degrees.

5. The separator of claim 4, wherein the geometric feature comprises at least one turn of 80 to 100 degrees.

6. The separator of claim 5, wherein the geometric feature comprises a chevron shaped feature including a first turn, a second turn and a third turn, such that the second turn comprises a turn of about 90 degrees located between the first and the third turns.

7. The separator of claim 3, wherein the geometric feature comprises a plurality of turns.

8. The separator of claim 3, further comprising a fuel inlet opening and a fuel outlet opening wherein the fuel inlet opening is in fluid communication with the fuel outlet opening through the plurality of channels.

9. The separator of claim 8, wherein a straight line path does not exist between the fuel inlet opening and the fuel outlet opening through the plurality of channels.

10. The separator of claim 2, wherein the geometric feature comprises a first portion of each channel which has a narrower width than a second portion of each channel.

11. The separator of claim 3, wherein each channel has a width of between 100 microns to 10 cm and wherein each gas flow restrictor has a narrower width than a width of each channel.

12. The separator of claim 2, wherein the gas flow separator comprises a plate shaped gas flow separator.

13. A fuel cell stack, comprising:
a plurality of fuel cells; and
a plurality of gas flow separators of claim 2 separating adjacent fuel cells.

14. The fuel cell stack of claim 13, wherein:
the fuel cells comprise planar solid oxide fuel cells; and
the gas flow separators comprise plate shaped gas flow separators.

15. The fuel cell stack of claim 14, wherein:
the fuel cell stack is internally manifolded for fuel flow and externally manifolded for air flow such that the gas flow separators contain fuel inlet and outlet riser openings and lack air inlet and outlet riser openings; and
the flow restrictors are located at least on a fuel side of the gas flow separators.

16. The fuel cell stack of claim 15, wherein the flow restrictors are located in the channels on a fuel side of the gas flow separators.

17. The fuel cell stack of claim 16, wherein:
the stack comprises a multiple level cascading fuel flow system; and
the gas flow separators equalize fuel flow rate among the multiple flow levels.

18. The fuel cell stack of claim 13, wherein the gas flow restrictors comprise a chevron shaped feature including a first turn, a second turn and a third turn, such that the second turn comprises a turn of about 90 degrees located between the first and the third turns.

19. A method of operating a fuel cell stack comprising a plurality of fuel cells and a plurality of gas flow separators of claim 2 separating adjacent fuel cells, wherein the method comprises:
providing an oxidizer flow to the fuel cells;
providing a fuel flow through the plurality of gas flow channels containing the gas flow restrictors such that the gas flow restrictors restrict fuel flow in the gas flow channels and govern a pressure drop in the gas flow channels; and
generating electricity in the fuel cells.

20. The method of claim 19, wherein the gas flow separators equalize the fuel flow rate among multiple levels in a multiple level cascading fuel flow network.

21. The method of claim 19, wherein the fuel cell stack comprises a solid oxide fuel cell stack which operates at a fuel utilization of 70 to 85 percent.

22. A device, comprising:
a plurality of gas or liquid flow channels containing a gas or liquid flow restrictor therein;
wherein:
each gas or liquid flow restrictor comprises a geometric feature which restricts gas or liquid flow in each respective channel; and
the geometric feature comprises a chevron shaped feature including a first turn, a second turn and a third turn, such that the second turn comprises a turn of about 90 degrees located between the first and the third turns.

23. The device of claim 22, wherein each geometric feature comprises a mitered corner.

24. The device of claim 22, wherein the device comprises a device containing a plurality of liquid flow channels.

25. The device of claim 22, wherein the device comprises a device containing a plurality of gas flow channels.

26. The device of claim 25, wherein the device comprises a gas flow separator for an electrochemical system.
